(19) United States
(12) Patent Application Publication
(10) Pub. No.: US 2010/0159184 A1
(43) Pub. Date: Jun. 24, 2010

(54) POLY-TRIMETHYLENE TEREPHTHALATE SOLID CORE FIBRILLATION-RESISTANT FILAMENT HAVING A SUBSTANTIALLY TRIANGULAR CROSS SECTION, A SPINNERET FOR PRODUCING THE FILAMENT, AND A CARPET MADE THEREFROM

(75) Inventors: HARRY VAUGHN SAMUELSON, Chadds Ford, PA (US); Kalika Ranjan Samant, Hockessin, DE (US); Jing-Chung Chang, Boothwyn, PA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY

(21) Appl. No.: 12/338,412

(22) Filed: Dec. 18, 2008

(51) Int. Cl. D02G 3/00; D05C 17/02; B29C 47/12

(52) U.S. Cl. 428/90; 428/400; 425/464; 264/177.13

(57) ABSTRACT

In a first aspect the invention is a solid core fibrillation-resistant, synthetic polymeric filament having three substantially equal length convex sides. The sides through substantially rounded tips centered by a distance “a” from the axis of the filament. Each rounded tip has a radius substantially equal to a length “b”. Each tip lies on a circumscribed circle having a radius substantially equal to a length (a+b) and the midpoint of each side lies on an inscribed circle having a radius substantially equal to a length “c”. The filament has a denier-per-filament in the range 10<“dpf”<35; the distance “a” lies in the range 0.00025 inches (6 micrometers)<“a”<0.004 inches (102 micrometers); the distance “b” lies in the range from 0.00008 inches (2 micrometers)<“b”<0.001 inches (24 micrometers); the distance “c” lies in the range from 0.0003 inches (8 micrometers)<“c”<0.0025 inches (64 micrometers); and the modification ratio (“MR”) lies in the range from about 1.1<“MR”< about 2.0.

In still another aspect the present invention is directed to a spinneret plate having a plurality of orifices formed therein for forming the solid core fibrillation-resistant, synthetic polymeric filament. Each orifice has a center and three sides with each side terminating in a first and a second end point and with a midpoint therebetween. The sides can be either concave or linear connected by either a circular or a linear end contour.

### BACKGROUND OF THE INVENTION

1. Field of the Invention

This invention relates to a poly-trimethylene terephthalate solid core fibrillation-resistant synthetic filament, to a spinneret for producing the filament, and to a carpet made therefrom

2. Description of the Art Background

The ability of a tufted carpet made from synthetic polymeric filaments to retain its textured appearance, or “newness”, tends to degrade over time. One cause of this appearance degradation is known as “fibrillation” that is produced by fraying of the carpet's filaments by use.

Various industry standard test methods, e.g., tetrapod walker test (ASTM D5251), hexapod walker test (ASTM D5252), Vetterman drum test (ASTM D5417), chair castor test and Phillips roll chair test are available to measure texture retention. Carpets samples are graded against a subjective scale after they have been subjected to these tests for predetermined number of cycles.

For example, tests performed on carpets made using petroleum-based poly-trimethylene terephthalate fibers having trilobal cross-section with a modification ratio of 2.0 and a 26.5 degree arm angle show significant fibrillation damage after 20,000 cycles in the Phillips roll chair test. Damaged trilobal filaments extracted from worn carpets after such test show severe deformities. One typical mode of deformation is manifested by adjacent lobes of the originally trilobal filament being bent toward each other, resulting in a filament having an elongated, compacted cross section.

In view of the foregoing it is desirable to produce filaments with cross-sections that are inherently more resistant to fibrillation, and are thereby able to provide superior texture retention during accelerated wear tests described above and exceptional durability in use.

### SUMMARY OF THE INVENTION

In a first aspect the present invention is directed toward a solid core, fibrillation-resistant, synthetic polymeric filament having three substantially equal length convex sides. Each side meets an adjacent side through a substantially rounded tip centered on a respective circle of curvature spaced from the axis of the filament by a distance “a”. Each rounded tip has a radius substantially equal to a length “b”.

Each tip lies on a circumscribed circle having a radius substantially equal to a length (a+b) and the midpoint of each side lies on an inscribed circle having a radius substantially equal to a length “c”. The filament having a modification ratio (MR) defined by the ratio of the radius (a+b) of the circumscribed circle to the radius (c) of the inscribed circle, wherein:
the filament has a denier-per-filament (“dpf”) in the range 10<“dpf”<35;
the distance “a” lies in the range 0.00025 inches (6 micrometers)<“a”<0.004 inches (102 micrometers);
the distance “b” lies in the range from 0.00008 inches (2 micrometers)<“b”<0.001 inches (24 micrometers);
the distance “c” lies in the range from 0.0003 inches (8 micrometers)<“c”<0.0025 inches (64 micrometers); and
the modification ratio (“MR”) lies in the range from about 1.1<“MR”< about 2.0.

More particularly,
the filament has a denier-per-filament (“dpf”) in the range 12<“dpf”<32;
the distance “a” lies in the range 0.00035 inches (9 micrometers)<“a”<0.003 inches (76 micrometers);
the distance “b” lies in the range from 0.00010 inches (3 micrometers)<“b”<0.00095 inches (25 micrometers);
the distance “c” lies in the range from 0.0005 inches (10 micrometers)<“c”<0.002 inches (51 micrometers); and
the modification ratio (“MR”) lies in the range from about 1.1<“MR”< about 2.0.

Preferably, the synthetic polymer is substantially poly-trimethylene terephthalate, and more preferably, the poly-trimethylene terephthalate has a 1,3propane diol that is biologically produced. Alternately, poly-trimethylene terephthalate may come from renewably resourced routes. The synthetic polymer may be pigmented and/or may have a delusterant therein.

The filament has a tenacity greater than 1.5 grams per denier.

-o-0-o-

In another aspect the present invention is directed to a carpet made from filaments as described above.

-o-0-o-

In still another aspect the present invention is directed to a spinneret plate having a plurality of orifices formed therein for forming the solid core fibrillation-resistant, synthetic polymeric filament. Each orifice has a center and three sides with each side terminating in a first and a second end point and with a midpoint therebetween.

In a first embodiment of a spinneret in accordance with this aspect of the invention the first end point of one side is connected to the second end point of an adjacent side by a circular end contour having a radius equal to a dimension “C”. The center point of each end contour is disposed a predetermined distance “D” from the center of the orifice.

In accordance with this embodiment:
the distance “C” lies in the range 0.0015 inches (38 micrometers)<“C”<0.0040 inches (102 micrometers);
the distance “D” lies in the range from 0.0150 inches (381 micrometers)<“D”<0.0300 inches (762 micrometers);
   and more particularly:
the distance “C” lies in the range 0.0020 inches (51 micrometers)<“C”<0.0035 inches (89 micrometers);
the distance “D” lies in the range from 0.0175 inches (445 micrometers)<“D”<0.0280 inches (711 micrometers).

In an alternate embodiment of a spinneret in accordance with this aspect of the invention the end contour connecting the first end point of one side to the second end point of an adjacent side is defined by at least two linear edges that intersect in an apex.

The first end point of each side is spaced from the second end point of an adjacent side by a baseline that itself intersects with a reference radius emanating from the center point. The intersection point between the baseline and the reference radius lies a distance “G” along the reference radius from the center of the orifice. The baseline has a predetermined length “2F”. The apex is spaced a dimension “E” from an intersection of the baseline and the reference radius.

In accordance with this embodiment:
the distance “E” lies in the range 0.0025 inches (64 micrometers)<“E”<0.0150 inches (381 micrometers);
the distance “F” lies in the range from 0.0015 inches (38 micrometers)<“F”<0.0040 inches (102 micrometers); and
the distance “G” lies in the range from 0.0150 inches (381 micrometers)<“G”<0.0300 inches (762 micrometers);
   and more particularly:
the distance “E” lies in the range 0.0030 inches (76 micrometers)<“E”<0.0100 inches (254 micrometers);
the distance “F” lies in the range from 0.0020 inches (51 micrometers)<“F”<0.0035 inches (89 micrometers); and
the distance “G” lies in the range from 0.0175 inches (445 micrometers)<“G”<0.0280 inches (711 micrometers).

Regardless of the form taken by the end contour, each side of the orifice may be either substantially concave or substantially linear.

If orifice has substantially concave sides, each side lies on a reference circle having a radius of dimension “B”. The center of the reference circle is located on a reference radius emanating from the center point of the orifice and passing through a midpoint of a side. The center of the reference circle is disposed a predetermined distance “A” along the reference radius from the central axis of the orifice.

The outermost point on each circular end contour lies on a circumscribed circle having a radius “(C+D)” (as defined above) centered on the center of the orifice. The midpoints of each side lying on a inscribed circle having a radius “H”. [In the case of an orifice with concave sides the radius “H” is equal to the value (A−B)].

The orifice has a modification ratio (“MR”) defined by the ratio of the radius (C+D) of the circumscribed circle to the radius “(A−B)” of the inscribed circle, thus,

“MR”=(C+D)/“(A−B)”, wherein
the distance “A” lies in the range 0.0300 inches (762 micrometers)<“A”<0.0900 inches (2286 micrometers);
the distance “B” lies in the range from 0.0200 inches (508 micrometers)<“B”<0.0800 inches (2032 micrometers);
the ratio (A/B) lies within the range from about 1.0<(A/B)< about 1.6; and
the modification ratio (“MR”) lies in the range from about 1.5<“MR”< about 4.5.
   More particularly:
the distance “A” lies in the range 0.0300 inches (762 micrometers)<“A”<0.0700 inches (2032 micrometers);
the distance “B” lies in the range from 0.0200 inches (508 micrometers)<“B”<0.0800 inches (1778 micrometers);
the ratio (A/B) lies within the range from about 1.1<(A/B)< about 1.5; and
the modification ratio (“MR”) lies in the range from about 1.8<“MR”< about 3.5.

If orifice has substantially linear sides with circular end contours the outermost point on each end contour again lies on a circumscribed circle having the radius “(C+D)” (as defined above) centered on the center of the orifice while the midpoints of each side lying on a inscribed circle having the radius “H” centered on the center of the orifice.

In the case of an orifice with linear sides and circular end contours the distance “H” (i.e., the radius of the inscribed circle) lies in the range from:

0.0090 inches (229 micrometers)<“H”<0.0190 inches (483 micrometers);

and more preferably, in the range from:

0.0108 inches (274 micrometers)<“H”<0.0175 inches (445 micrometers).

The modification ratio (“MR”) for such an orifice with substantially linear sides is also defined by the ratio of the radius (C+D) of the circumscribed circle to the radius “H” of the inscribed circle, thus,

“MR”=(C+D)/“H”.

The modification ratio (“MR”) lies in the range from about 1.6<“MR”< about 2.5; and more particularly, the modification ratio (“MR”) lies in the range from about 1.7<“MR”< about 2.3.

For orifices having linear sides and linear end contours the distance “H” (i.e., the radius of the inscribed circle) lies in the range from:

0.0088 inches (224 micrometers)<“H”<0.0185 inches (470 micrometers)

and more preferably, in the range from:

0.0105 inches (267 micrometers)<“H”<0.0170 inches (432 micrometers).

The modification ratio (“MR”) for orifices having linear sides and linear end contours is also defined by the ratio of the radius (E+G) of the circumscribed circle to the radius “H” of the inscribed circle, thus,

“MR”=(E+G)/“H”

The modification ratio (“MR”) lies in the range from about 1.6<“MR”< about 2.5, and more particularly, the modification ratio (“MR”) lies in the range from about 1.7<“MR”< about 2.3.

### BRIEF DESCRIPTION OF THE DRAWINGS

The invention will be more fully understood from the following detailed description taken in connection with the accompanying Figures, which form a part of this application and in which:

FIG. 1 is an end view of a filament in accordance with the present invention taken in a plane perpendicular to the longitudinal axis of the filament;

FIG. 2A is an end view a first embodiment of a spinneret plate having a filament-forming orifice formed therethrough for producing a filament in accordance with the present invention, the view being taken in a plane perpendicular to the central axis of the filament-forming orifice with the orifice having rounded end contour regions and concave sides;

FIG. 2B is an end view, similar to the view of FIG. 2A, showing an alternate embodiment of a spinneret plate for producing a filament in accordance with the present invention, the filament-forming orifice having rounded end contour regions and linear sides;

FIG. 3A is an end view an alternate embodiment of a spinneret plate generally similar to that shown in FIG. 2A in that the orifice has concave sides, but with end contour regions each comprising at least two linear edges;

FIG. 3B is an end view an alternate embodiment of a spinneret plate generally similar to that shown in FIG. 2B in that the orifice has linear sides, but with end contour regions each comprising at least two linear edges;

FIG. 4 is stylized diagrammatic illustration of a spinning arrangement that utilizes a spinneret plate as shown in FIGS. 2A, 2B, 2C, 3A or 3B for spinning filaments in accordance with the invention;

FIG. 5 is stylized diagrammatic illustration of a carpet fabricated using filaments of the invention;

FIG. 6A is stylized diagrammatic side sectional illustration of a rotating ball mill test chamber used to test filaments of the invention;

FIG. 6B is a diagrammatic end view illustrating the operation of the ball mill test when testing filaments of the present invention;

FIGS. 7A and 7B are photographs illustrating a comparative trilobal cross section filament before and after fibrillation testing using the rotating ball mill test chamber of FIG. 6A;

FIGS. 8A and 8B are photographs illustrating a comparative round cross section filament before and after fibrillation testing using the rotating ball mill test chamber of FIG. 6A; and

FIGS. 9A and 9B are photographs illustrating a filament in accordance with the present invention before and after fibrillation testing using the rotating ball mill test chamber of FIG. 6A.

### DETAILED DESCRIPTION OF THE INVENTION

Throughout the following detailed description similar reference numerals refer to similar elements in all figures of the drawings.

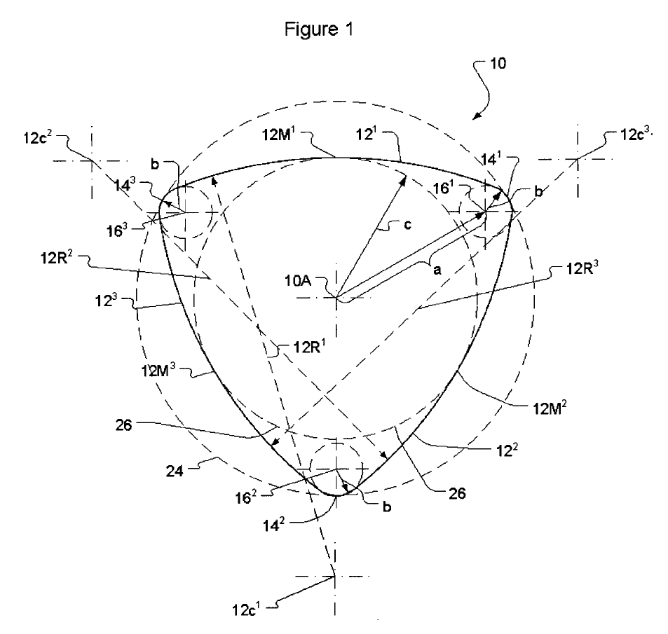

FIG. 1 is a cross-section view through a solid core, fibrillation-resistant, synthetic polymeric filament 10 in accordance with one aspect of the present invention, taken in a plane substantially perpendicular to the central longitudinal axis 10A of the filament.

The filament 10 is preferably fabricated from a poly-trimethylene terephthalate polymeric material. More preferably, the poly-trimethylene terephthalate polymeric material wherein the 1,3propane diol is biologically produced, although it should also be understood that the 1,3propane diol derived via a petroleum route may also used in combination with biologically based 1,3propane diol.

The polymeric material may be pigmented with a solution dyed color additive or a delusterant such as TiO2. Alternatively, the polymeric material may be non-pigmented for later dying. The polymeric material may contain UV stabilizers, anti-oxidants and/or other performance-improving additives (including toughening agents and/or nucleation-inhibiting agents).

The filament may also be fabricated from other polymeric materials, such as polyester, nylon, polypropylene and blends thereof.

As seen from FIG. 1 the filament 10 is, in the cross section plane perpendicular to its axis, three-sided in form. The sides 12¹, 12², 12³ are substantially equal in length. Each side 12¹, 12², 12³ is generally convex in shape with a mid-point 12M¹, 12M², 12M³ therealong. Each side 12¹, 12², 12³ lies on a respective circle of curvature having a radius 12R¹, 12R², 12R³. Each circle of curvature is centered on a respective center point 12C¹, 12C², 12C³. The center points 12C¹, 12C², 12C³ each lie on a respective reference radius emanating from the axis 10A of the filament 10.

Each respective side 12¹, 12², 12³ meets with a side adjacent thereto through a substantially rounded tip 14¹, 14², 14³, respectively. The rounded contour of each tip 14¹, 14², 14³ lies on a circle of curvature centered on a respective center point 16¹, 16², 16³. The radius of the circle of curvature of the tips 14¹, 14², 14³ is indicated by the reference character “b”. Each center of curvature 16¹, 16², 16³ is itself spaced by a predetermined distance “a” from the central axis 10A of the filament. Only one center of curvature (16¹) is shown for clarity of illustration

The outermost point of each tip 14¹, 14², 14³ of the filament 10 lies on a circumscribed circle 24 having a radius substantially equal to a length (a+b). The midpoint 12M¹, 12M², 12M³ of each respective side 12¹, 12², 12³ lies on an inscribed circle 26 centered on the central axis 10A of the filament 10. The radius of the inscribed circle 26 is substantially equal to a length “c”. Accordingly, the filament 10 exhibits a modification ratio (“MR”) defined by the ratio of the radius (a+b) of the circumscribed circle to the radius (c) of the inscribed circle, thus: MR=(a+b)/c.

Mathematical modeling of filaments having trilobal cross-section shows that lobes and the sides are susceptible to failure under compressive, bending and/or torsion loads. The effect of these stresses acting upon the filaments result in fibrillation and the corresponding texture degradation of the filament during wear.

Analyses also indicate that maximum bending stress is imposed on the end contour regions of the filament, while maximum torsion and compression forces are imposed substantially centrally along the sides of the filament. For example, the compressive stress (“σ”) at the contact point between two adjacent filaments has been found to be inversely proportional to the square root of filament diameter “d” when filaments are parallel to each other,
thus, σ=d^{-1/2}.

In the case where the where the filaments are perpendicular to each other, the compressive stress (“σ”) is inversely proportional to the ⅔^{rd} power of filament diameter, thus, σ=d^{-2/3}.

As will be developed it is believed that the fiber geometry disclosed by this invention reduces these stress levels, resulting in a filament having improved fibrillation resistant properties. Filaments in accordance with the present invention are believed to overcome weaknesses of round as well as trilobal cross-sections under various loading conditions.

In particular, it has been found that forming a filament with more robust end contours and more robust filament tip region will counteract bending stress imposed on the filament. If the radius of the circle of curvature of the tips 14¹, 14², 14³ is kept large stress levels at tips are lowered below the levels occurring at the lobes of a trilobal cross-section.

Likewise, as opposed to filaments having a round cross-section, configuring the filament with flatter, less concave sides result in filaments more able to retain their shape in the face of forces imposed by use. Filaments with large radii 12R¹, 12R², 12R³ relative to the diameter of a round filament having an equivalent cross-sectional area lead to a substantial reduction in the compressive contact stress over round filaments.

Accordingly, filaments in accordance with the present invention exhibit various dimensional parameters and certain relationships therebetween, as follows:
the filament has a denier-per-filament (“dpf”) in the range 10<“dpf”<35;
the distance “a” lies in the range 0.0003 inches (6 micrometers)<“a”<0.004 inches (102 micrometers);
the distance “b” lies in the range from 0.00008 inches (2 micrometers)<“b”<0.0001 inches (24 micrometers);
the distance “c” lies in the range from 0.0003 inches (8 micrometers)<“c”<0.0025 inches (64 micrometers); and
the modification ratio (“MR”) lies in the range from about 1.1<“MR”< about 2.0.

In a more preferred instance:
the filament has a denier-per-filament (“dpf”) in the range 12<“dpf”<32;
the distance “a” lies in the range 0.00035 inches (9 micrometers)<“a”<0.003 inches (76 micrometers);
the distance “b” lies in the range from 0.00010 inches (3 micrometers)<“b”<0.00095 inches (25 micrometers);
the distance “c” lies in the range from 0.0005 inches (10 micrometers)<“c”<0.002 inches (51 micrometers); and
the modification ratio (“MR”) lies in the range from about 1.1<“MR”< about 2.0.

Preferably, the filament has a tenacity greater than 1.5 grams per denier.

-o-0-o-

In another aspect the present invention is directed to a spinneret plate 100 for forming a solid core, fibrillation-resistant, synthetic polymeric filament. The plate 100 is a relatively massive member having a plurality of filament-forming orifices 102 provided therethrough. Each orifice has a center 102A. The plate 100 may be fabricated from a material such as stainless steel. Suitable grades of stainless steel include 440C, 316, 17-4 PH, 430, or Carpenter 20. The steel grade selected should be free of internal defects. Typically the orifices are formed through the plate 100 using machining technology such as laser cutting or electrical discharge machining.

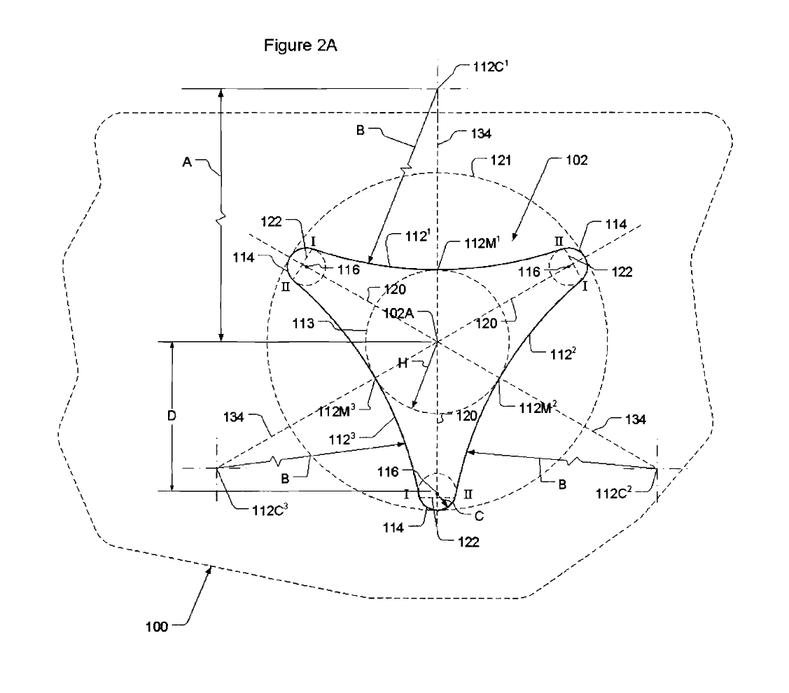

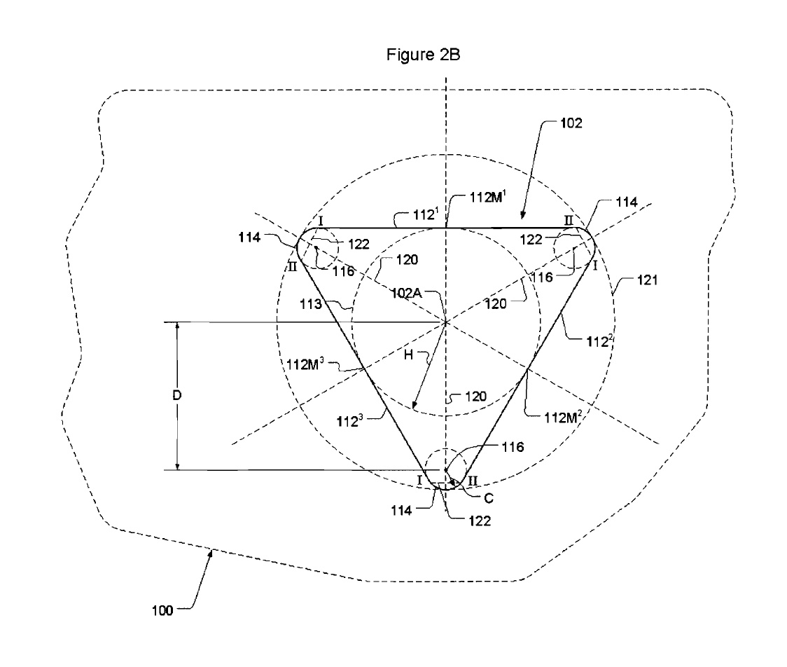

An enlarged view of a portion of the surface of a spinneret plate 100 and one of the orifices 102 formed therein is shown FIGS. 2A, 2B, 3A and 3B. Each of these Figures illustrates one of the various alternative configurations of an single orifice 102 in accordance with various embodiments of the present invention.

In general, for each embodiment of this aspect of the invention a filament-forming orifice 102 is an aperture having three substantially equal length sides 112¹, 112², 112³. The midpoint 112M¹, 112M², 112M³ of each side lies on an inscribed circle 113 having a radius “H” centered on the center point 102A of the orifice. Each of the sides 112¹, 112², 112³ terminates in a first and a second end point, respectively indicated in the drawings by the Roman numerals I, II.

The first end point I of any one side is connected to the second end point II of an adjacent side by an end contour 114, 114′. The end contour 114, 114′ in each of the embodiments of FIGS. 2A, 2B and FIGS. 3A and 3B take alternative forms.

In the embodiments illustrated in FIGS. 2A and 2B the end contour 114 takes the form of a circle centered on center point 116 and having a radius of the dimension “C”. Each center point 116 is spaced a predetermined distance “D” along a reference radius 120 emanating from the center 102A of the orifice. The outermost point on each circular end contour 114 lies on a circumscribed circle 121 centered on the center 102A of the orifice and having a radius “(C+D)”. The first end point I of any one side and the second end point II of an adjacent side are spaced from each other by a chord 122 of the circular end contour. Each end point I, II defines a point of tangency of the circular end contour 114.

The modification ratio (“MR”) of an orifice is defined as the ratio of the radius of a circumscribed circle of the orifice to the radius of the inscribed circle of the orifice.

In a preferred implementation of this embodiment of the invention shown in FIGS. 2A and 2B:
the distance “C” lies in the range 0.0015 inches (38 micrometers)<“C”<0.0040 inches (102 micrometers);
the distance “D” lies in the range from 0.0150 inches (381 micrometers)<“D”<0.0300 inches (762 micrometers).
   In a more preferred case:
the distance “C” lies in the range 0.0020 inches (51 micrometers)<“C”<0.0035 inches (89 micrometers);
the distance “D” lies in the range from 0.0175 inches (445 micrometers)<“D”<0.0280 inches (711 micrometers).

Alternatively, in the embodiments illustrated in FIGS. 3A and 3B, each end contours 114′ is defined by at least two linear edges 126A, 126B. Any convenient number of linear edge segments may be used to define an end contour 114′. In these embodiments the first end point I of any one side and the second end point II of an adjacent side are spaced from each other by a baseline 128 having a length “2F”. Each baseline 128 lies a predetermined distance “G” on the reference radius 120. The linear edges 126A, 126B of the contour 114′ intersect each other at an apex 130 also lying on the reference radius 120. The apex 130 is spaced a distance “E” from the baseline 128.

The apex 130 of each end contour 114′ lies on a circumscribed circle 121 centered on the center 102A of the orifice. In these Figures the circumscribed circle 121 has a radius “(G+E)”.

In accordance with this embodiment of the invention shown in FIGS. 3A and 3B:
the distance “E” lies in the range 0.0025 inches (64 micrometers)<“E”<0.0150 inches (381 micrometers);
the distance “F” lies in the range from 0.0015 inches (38 micrometers)<“F”<0.0040 inches (102 micrometers); and
the distance “G” lies in the range from 0.0150 inches (381 micrometers)<“G”<0.0300 inches (762 micrometers).
   More preferably:
the distance “E” lies in the range 0.0030 inches (76 micrometers)<“E”<0.0100 inches (254 micrometers);
the distance “F” lies in the range from 0.0020 inches (51 micrometers)<“F”<0.0035 inches (89 micrometers); and
the distance “G” lies in the range from 0.0175 inches (445 micrometers)<“G”<0.0280 inches (711 micrometers).

The orifices 102 as illustrated in FIGS. 2A and 3A also differ from those shown in FIGS. 2B and 3B in the form taken by the sides 112.

In the embodiments of FIGS. 2A and 3A the sides 112¹, 112², 112³ are generally concave in shape and lie along a circle of curvature centered on a respective center of curvature 112C¹, 112C², 112C³. Each center of curvature 112C¹, 112C², 112C³ is located on a reference line 134 emanating radially from the central axis 102A of the orifice. The radius of the circle of curvature has a dimension indicated by the reference character “B”. Each center of curvature 112C¹, 112C², 112C³ is located a predetermined distance “A” from the central axis 102A. It should be noted that the radius “H” of the inscribed circle 113 is equal to (A−B).

For orifices having concave sides as shown in FIGS. 2A and 3A the following additional dimensional constraints apply:
the distance “A” lies in the range 0.0300 inches (762 micrometers)<“A”<0.0900 inches (2286 micrometers);
the distance “B” lies in the range from 0.0200 inches (508 micrometers)<“B”<0.0800 inches (2032 micrometers);
the ratio (A/B) lies within the range from about 1.0<(A/B)< about 1.6; and
the modification ratio (“MR”) lies in the range from about 1.5<“MR”< about 4.5.

More preferably:
the distance “A” lies in the range 0.0300 inches (762 micrometers)<“A”<0.0800 inches (2032 micrometers);
the distance “B” lies in the range from 0.0200 inches (508 micrometers)<“B”<0.0700 inches (1778 micrometers);
the ratio (A/B) lies within the range from about 1.1<(A/B)< about 1.5; and
the modification ratio (“MR”) lies in the range from about 1.8<“MR”< about 3.5.

For orifices having concave sides (FIGS. 2A and 3A) the modification ratio (“MR”) lies in the range from about 2.0<“MR”< about 4.0. More preferably, the modification ratio (“MR”) lies in the range from about 2.2<“MR”< about 3.5.

As the radius of the circle of curvature of the side of the orifice is increased the contour of the side flattens, until at a very large radius the side becomes close to linear.

For orifices having linear sides and circular end contours (FIG. 2B) the distance “H” (i.e., the radius of the inscribed circle) lies in the range from 0.0090 inches (229 micrometers)<“H”<0.0190 inches (483 micrometers). The modification ratio (“MR”) lies in the range from about 1.6<“MR”< about 2.5. More preferably, the distance “H” lies in the range from 0.0108 inches (274 micrometers)<“H”<0.0175 inches (445 micrometers) and the modification ratio (“MR”) lies in the range from about 1.7<“MR”< about 2.3.

For orifices having linear sides and linear end contours (FIG. 3B) the distance “H” (i.e., the radius of the inscribed circle) lies in the range from 0.0088 inches (224 micrometers)<“H”<0.0185 inches (470 micrometers). The modification ratio (“MR”) lies in the range from about 1.6<“MR”< about 2.5. More preferably, the distance “H” lies in the range from 0.0105 inches (267 micrometers)<“H”<0.0170 inches (432 micrometers) and the modification ratio (“MR”) lies in the range from about 1.7<“MR”< about 2.3.

-o-0-o-

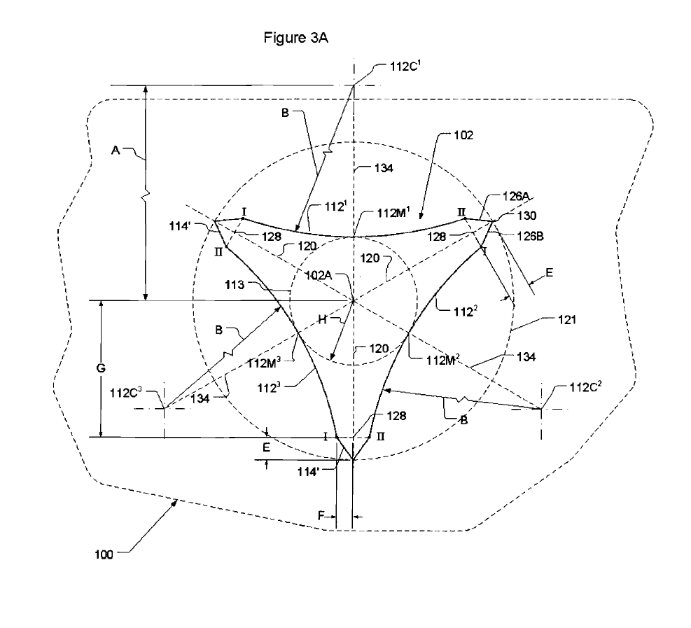

FIG. 4 is stylized diagrammatic illustration of a spinning arrangement generally indicated by the reference character 200 for manufacturing bulked continuous filaments of present invention. Polymer melt is pumped through spin pack assembly 202 that includes a spinneret plate 100 having a plurality of orifices 102 shaped in accordance with this invention. The spin pack assembly 202 may also contain a filtration medium.

Filaments 10 of desired shapes are obtained when polymer is extruded through the spinneret plate 100 and filaments are pulled through a quench chimney 204 by feed rolls 206. Finish is applied to the filaments 10 for downstream processability by a finish roll 208 located prior to the feed rolls 206. The feed rolls 206 are kept at the room temperature or maintained at a temperature above polymer glass transition temperature to effectively draw and orient molecules during the draw process. Draw rolls 210, running at a predetermined speed faster than the feed rolls 206 by the amount of the draw ratio, are heated to a temperature above the glass transition temperature and below the melting point of the polymer to anneal the drawn fiber. At this point the filaments may be collected by a winder 212 through a let down roll 212 or continue for further processing.

A bulking jet 220 employing hot air or steam is used to impart a random, three-dimensional curvilinear crimp to the filaments. The resulting bulked filaments are laid on to a rotating drum 224 having a perforated surface. The filaments are cooled under zero tension by pulling air through them using a vacuum pump. Water may additionally be misted onto the filaments on the drum 224 to facilitate cooling. After the filaments have been cooled below the glass transition temperature, filaments are pulled off the drum 224. If desired another finish for mill processing may applied by finish roll 226. The filament bundle is interlaced periodically by an interlacing jet 230 disposed between a pull roll 232 and a let down roll 234, and collected by a winder 236.

-o-0-o-

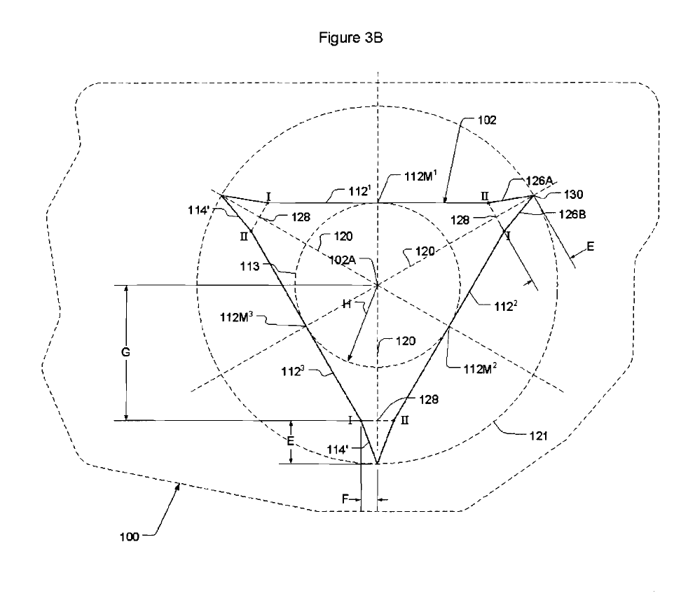

FIG. 5 is stylized diagrammatic illustration of a carpet generally indicated by the reference character 300 having tufted with yarn 302 made from filaments 10 of the present invention. In the embodiment illustrated the yarn 302 is formed from two twisted and heat-set filaments. Alternatively, the yarn could be formed by air-entangling filaments 10 or the yarn could be directly tufted without twisting or entanglement.

The yarn is tufted through a primary backing 304 to form pile tufts 306. The pile tufts 306 may take the level loop form shown in FIG. 5. Alternatively, the pile tufts may be multi-level loop, berber, plush, saxony, frieze or sheared form.

The carpet 300 is completed by a secondary 308 adhered to the primary backing 304 using an adhesive 310.

Other potential end uses of the filaments of the present invention include luggage, handbags, automotive fabrics.

-o-0-o-

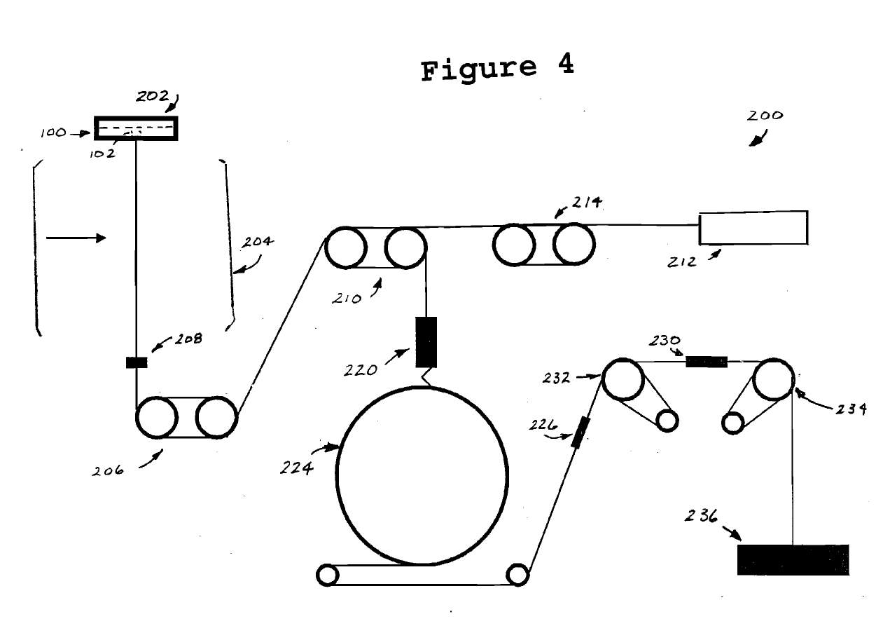

FIG. 6A is stylized diagrammatic illustration, taken in side section, of a rotating ball mill test chamber 400 used to test filaments 10 of the invention. FIG. 6B is a diagrammatic end view illustrating the operation of the ball mill test when testing filaments of the present invention.

The test chamber 400 comprises a cylindrical barrel 402 closed at one end by an integral base 404. The opposite end of the barrel 402 receives a lid 406. The lid 406 is secured to the rim of the barrel 402 by bolts 408. Both the base 404 and the lid 406 have an array of axially aligned mounting apertures 410 formed therein.

Access to the interior of the barrel 402 is afforded through a port opening 412 provided in the center of the lid 406. The port opening 412 is closed by a removable hatch 416. The hatch 416 is secured to the lid 406 by a screws 418.

To prepare the chamber for a test, bundles of filaments 10 under test are strung between the base 404 and the lid 406 using the mounting apertures 410. The filaments under test may be conveniently secured to the surfaces of the base 404 and the lid 406, as by tape. Any convenient number of ball bearings 420 (FIG. 6B) are introduced into the chamber through the port opening 412 and the hatch 416 secured. Nine millimeter (9 mm) stainless steel ball bearings may be used.

The dynamics of a filament test using the test chamber 400 are illustrated in FIG. 6B. The test chamber 400 is placed on two driven bars 424A, 424B of a rotating mill apparatus, such as a device manufactured by U.S. Stoneware, a division of E.R. Advanced Ceramics, East Palatine, Ohio. As the bars 424 are rotated in the direction 428 the bearings 420 impinge on the filaments 10 strung axially across the interior of the barrel. The test may be conducted for any convenient time period at a nominal rotational speed of one hundred rpm, although other speeds in the range from about 30 to about 120 rpms may be suitable employed.

Fiber cross-section images of the filaments tested using the test chamber 400 indicate fibrillation damage to the filaments that is similar to the fibrillation damage done to filaments of a carpet subjected to any of the various industry standard test methods used to measure texture retention. The similarity of fibrillation damage lends confidence to conclusions regarding the fillibration resistance of filaments tested using the chamber 400.

-o-0-o-

### EXAMPLES

Example 1 Using a spinning arrangement as shown in FIG. 4 bio-based poly-trimethylene terephthalate polymer having an intrinsic viscosity of 1.02 and less than 50 ppm moisture was spun through a 17-hole spinneret suitable for trilobal cross-section filaments. The temperature set points for downstream barrels of the 28-mm Warner & Pfleiderer twin extruder, transfer line, pumps, pack and die were in the range of 268-270° C. The spinning throughput was 60 grams per minute. The molten filaments were cooled in the chimney, where the room air was blown past the filaments using a profiled quench with air velocity in the range of 21-30 feet per minute as a function of distance from the spinneret face with higher velocity near the spinneret. Filaments were pulled by a pair of feed rolls at 60° C. at a surface speed of 600 meters per minute through the quench zone. Filaments were coated with a lubricant immediately prior to the feed roll. The coated filaments were drawn by a draw ratio of 3 and annealed by a pair of rolls heated to 160° C. with a surface speed of 1800 meters/minute. The filaments were then wound.

Filaments produced had the following properties:
Denier per filament=approximately 18
MR=2.1
Arm angle=22°
Tenacity of yarn, as produced, was 2.02 gm/denier.

Two hundred sixty filaments were strung through the rotating ball mill test chamber 400, described earlier, under a tension of approximately 20 gm without imparting any substantial twist to the yarn bundle. One hundred 9 mm stainless steel ball bearings were placed in the chamber. The test was conducted for 16 hours at 100 rpm.

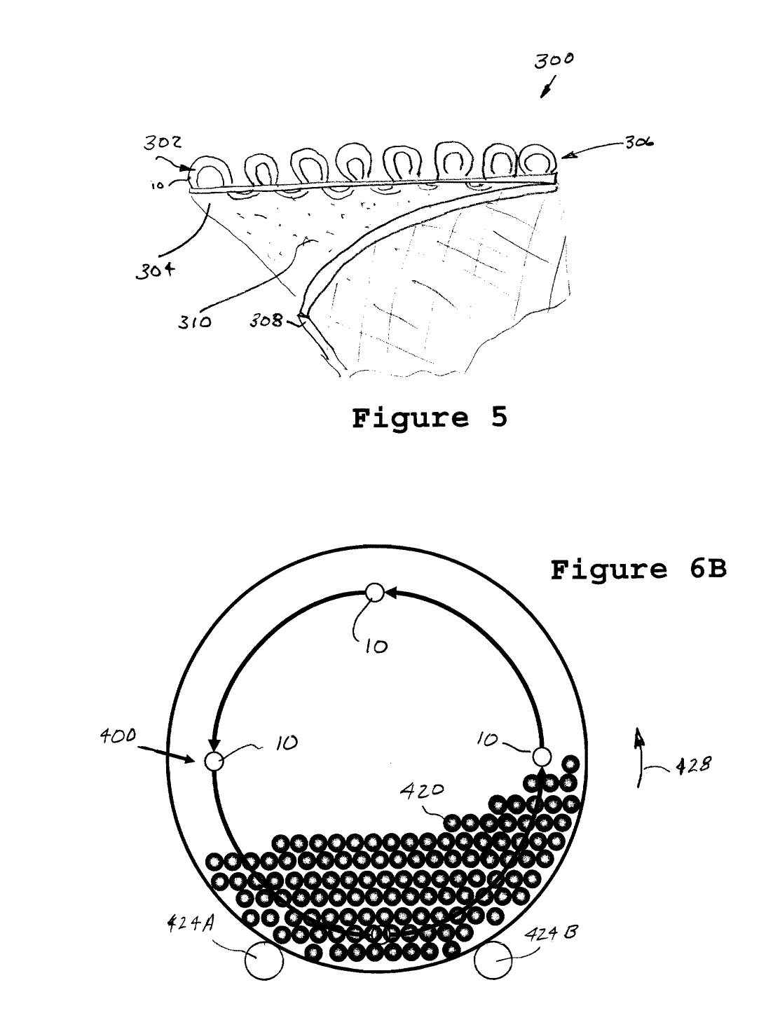

Cross-sectional images of yarn bundles were obtained before and after the 16 hour test using a Hardy plate and an optical microscope and are shown in FIGS. 7A and 7B, respectively.

Example 2 Using a spinning arrangement as shown in FIG. 4 bio-based poly-trimethylene terephthalate polymer having an intrinsic viscosity of 1.02 and less than 50 ppm moisture was spun through a 34-hole spinneret suitable for round cross-section filaments. The temperature set points for downstream barrels of the 28-mm Warner & Pfleiderer twin extruder, transfer line, pumps, pack and die were in the range of 268-270° C. The spinning throughput was 88.1 grams per minute. The molten filaments were cooled in the chimney, where the room air was blown past the filaments using a profiled quench with air velocity in the range of 21-30 feet per minute as a function of distance from the spinneret face with higher velocity near the spinneret. Filaments were pulled by a pair of feed rolls at 60° C. at a surface speed of 415 meters per minute through the quench zone. Filaments were coated with a lubricant immediately prior to the feed roll. The coated filaments were drawn by a draw ratio of 3.25 and annealed by a pair of rolls heated to 160° C. with a surface speed of 1350 meters/minute. The filaments were then wound. Denier per filament was approximately 18. Tenacity of yarn, as produced, was 2.75 gm/denier.

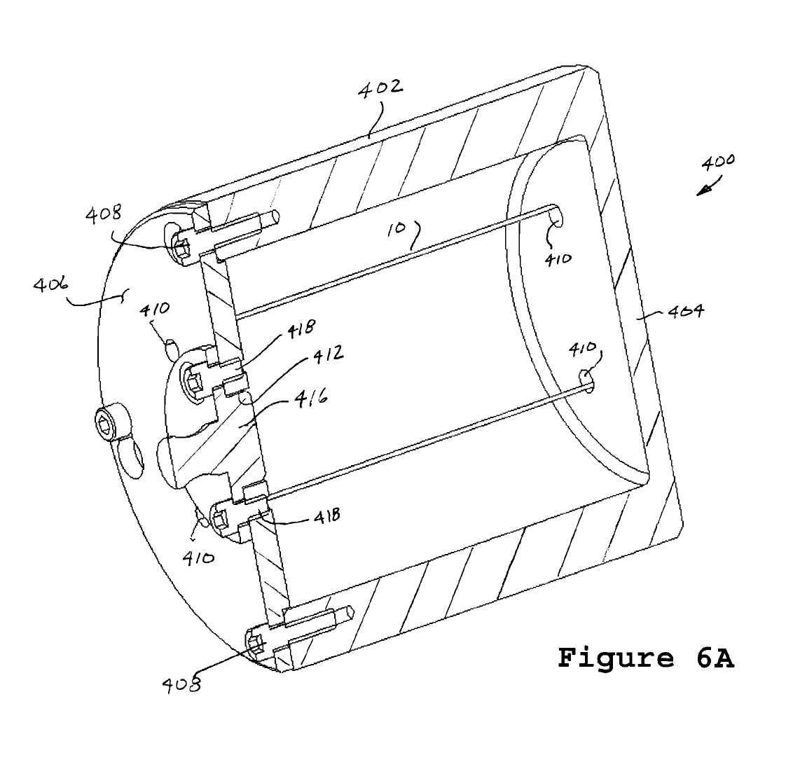

Two hundred seventy two filaments were strung through the rotating ball mill test chamber 400, described earlier, under a tension of approximately 20 gm without imparting any substantial twist to the yarn bundle. One hundred 9 mm stainless steel ball bearings were placed in the device. The test was conducted for 16 hours at 100 rpm. Cross-section images of yarn bundles were obtained before and after the 16 hour test using a Hardy plate and an optical microscope and are shown in FIGS. 8A and 8B, respectively.

Example 3 Using a spinning arrangement as shown in FIG. 4 bio-based poly-trimethylene terephthalate polymer having an intrinsic viscosity of 1.02 and less than 50 ppm moisture was spun through a 10-hole spinneret of present invention with following dimensions (FIG. 3A):
A=0.066 inch,
B=0.0554 inch,
F=0.0028 inch,
G=0.0225 inch,
E=0.0047 inch,
A/B=1.19,
2F/G=0.249,
E/D=0.21,
modification ratio MR=2.6.

The temperature set points for downstream barrels of the 28-mm Warner & Pfleiderer twin extruder, transfer line, pumps, pack and die were in the range of 268-270° C. The spinning throughput was 30 grams per minute. The molten filaments were cooled in the chimney, where the room air was blown past the filaments using a profiled quench with air velocity in the range of 21-30 feet per minute as a function of distance from the spinneret face with higher velocity near the spinneret. Filaments were pulled by a pair of feed rolls at 60° C. at a surface speed of 500 meters per minute through the quench zone. Filaments were coated with a lubricant immediately prior to the feed roll. The coated filaments were drawn by a draw ratio of 3 and annealed by a pair of rolls heated to 160° C. with a surface speed of 1500 meters/minute. The filaments were then wound.

Filaments produced had the following properties:
Denier per filament=approximately 18
a=0.00083 inch
b=0.00025 inch
c=0.00077 inch
MR=1.406
Tenacity of yarn, as produced, was 1.99 gm/denier.

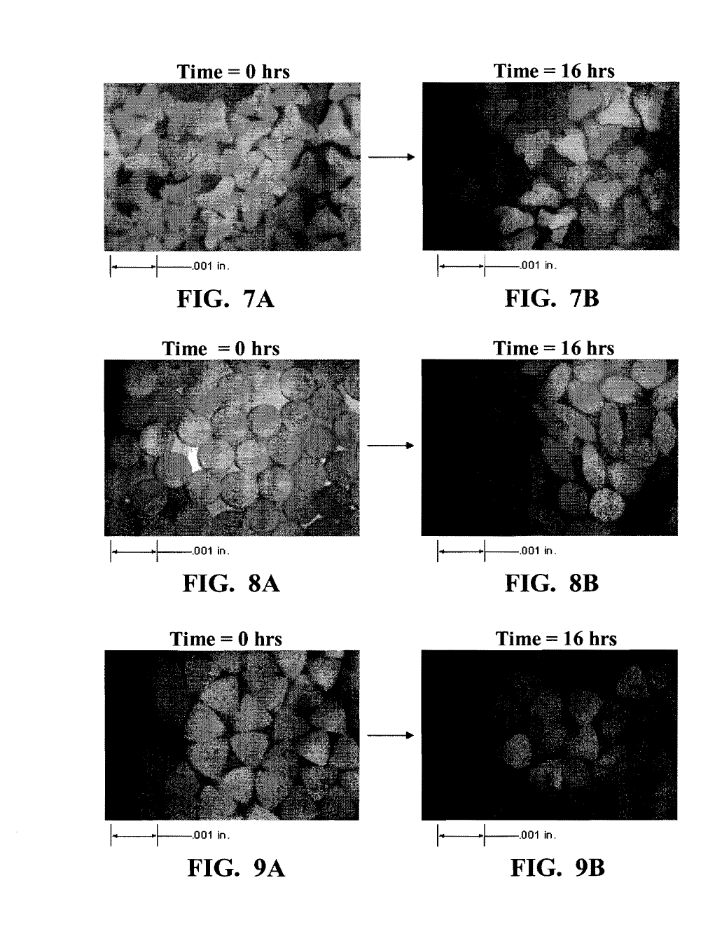

Two hundred sixty filaments were strung through the rotating ball mill test chamber 400, described earlier, under a tension of approximately 20 gm without imparting any substantial twist to the yarn bundle. One hundred 9 mm stainless steel ball bearings were placed in the device. The test was conducted for 16 hours at 100 rpm. Cross-section images of yarn bundles were obtained before and after the 16 hour test using a Hardy plate and an optical microscope and are shown in FIGS. 9A and 9B, respectively.

Fibrillation-resistant behavior of cross-section of a filament in accordance with the present invention is easily seen from comparison of the image in FIG. 9B with the images of the comparative examples shown in FIGS. 7B and 8B. Comparing FIGS. 7A and 7B, bending and severing of the lobes, indicating excessive fibrillation is easily seen. Similarly, there is excessive deformation of filaments having round cross-section as seen from FIGS. 8A and 8B. By contrast, very little deformation is seen in FIG. 9B when compared to as-produced filaments before the ball mill test, shown in FIG. 9A.

What is claimed is:

1. A solid core, fibrillation-resistant, synthetic polymeric filament having a longitudinal axis extending therethrough and a three-sided cross section in a plane perpendicular to the longitudinal axis,
the sides being substantially equal in length and convex in form, each side having a midpoint therealong, each midpoint lying on an inscribed circle centered on the central axis of the filament, the inscribed circle having a radius substantially equal to a length “c”,
each side meeting an adjacent side through a substantially rounded tip centered on a respective circle of curvature, each circle of curvature having a radius substantially equal to a length “b”, each circle of curvature being spaced from the axis of the filament by a distance “a”, each tip of the filament lying on a circumscribed circle having a radius substantially equal to a length (a+b),
the filament having a modification ratio (MR) defined by the ratio of the radius (a+b) of the circumscribed circle to the radius (c) of the inscribed circle, wherein
the filament has a denier-per-filament (“dpf”) in the range 10<“dpf”<35;
the distance “a” lies in the range 0.00025 inches (6 micrometers)<“a”<0.004 inches (102 micrometers);
the distance “b” lies in the range from 0.00008 inches (2 micrometers)<“b”<0.0010 inches (24 micrometers);
the distance “c” lies in the range from 0.0003 inches (8 micrometers)<“c”<0.0025 inches (64 micrometers); and
the modification ratio (“MR”) lies in the range from about 1.1<“MR”< about 2.0.

2. The filament of claim 1 wherein the filament has a tenacity greater than 1.5 grams per denier.

3. The filament of claim 1 wherein
the filament has a denier-per-filament (“dpf”) in the range 12<“dpf”<32;
the distance “a” lies in the range 0.00035 inches (9 micrometers)<“a”<0.003 inches (76 micrometers);
the distance “b” lies in the range from 0.00010 inches (3 micrometers)<“b”<0.00095 inches (25 micrometers);
the distance “c” lies in the range from 0.0005 inches (10 micrometers)<“c”<0.002 inches (51 micrometers); and
the modification ratio (“MR”) lies in the range from about 1.1<“MR”< about 2.0.

4. The filament of claim 1 wherein the synthetic polymer is poly-trimethylene terephthalate.

5. The filament of claim 4 wherein the poly-trimethylene terephthalate has a delusterant therein.

6. The filament of claim 4 wherein the poly-trimethylene terephthalate is pigmented.

7. The filament of claim 4 wherein the poly-trimethylene terephthalate has a 1,3propane diol that is biologically produced.

8. The filament of claim 1 wherein the synthetic polymer is poly-ethylene terephthalate, nylon, polypropylene or blends thereof.

9. A carpet having a backing and a plurality of tufts attached to the backing,
each tuft having a solid core, fibrillation-resistant, synthetic polymeric filament having a longitudinal axis extending therethrough and a three-sided cross section in a plane perpendicular to the longitudinal axis,
the sides being substantially equal in length and convex in form, each side having a midpoint therealong, each midpoint lying on an inscribed circle centered on the central axis of the filament, the inscribed circle having a radius substantially equal to a length “c”,
each side meeting an adjacent side through a substantially rounded tip centered on a respective circle of curvature, each circle of curvature having a radius substantially equal to a length “b”, each circle of curvature being spaced from the axis of the filament by a distance “a”, each tip of the filament lying on a circumscribed circle having a radius substantially equal to a length (a+b),
the filament having a modification ratio (MR) defined by the ratio of the radius (a+b) of the circumscribed circle to the radius (c) of the inscribed circle, wherein
the filament has a denier-per-filament (“dpf”) in the range 10<“dpf”<35;
the distance “a” lies in the range 0.00025 inches (6 micrometers)<“a”<0.004 inches (102 micrometers);
the distance “b” lies in the range from 0.00008 inches (2 micrometers)<“b”<0.001 inches (24 micrometers);
the distance “c” lies in the range from 0.0003 inches (8 micrometers)<“c”<0.0025 inches (64 micrometers); and
the modification ratio (“MR”) lies in the range from about 1.1<“MR”< about 2.0.

10. The carpet of claim 9 wherein filament has a tenacity greater than 1.5 grams per denier.

11. The carpet of claim 9 wherein
the filament has a denier-per-filament (“dpf”) in the range 12<“dpf”<32;
the distance “a” lies in the range 0.00035 inches (9 micrometers)<“a”<0.003 inches (76 micrometers);
the distance “b” lies in the range from 0.00010 inches (3 micrometers)<“b”<0.00095 inches (25 micrometers);
the distance “c” lies in the range from 0.0005 inches (10 micrometers)<“c”<0.002 inches (51 micrometers); and
the modification ratio (“MR”) lies in the range from about 1.1<“MR”< about 2.0.

12. The carpet of claim 9 wherein the synthetic polymer is poly-trimethylene terephthalate.

13. The carpet of claim 12 wherein the poly-trimethylene terephthalate has a delusterant therein.

14. The filament of claim 12 wherein the poly-trimethylene terephthalate is pigmented.

15. The carpet of claim 9 wherein the poly-trimethylene terephthalate has a 1,3propane diol that is biologically produced.

16. The carpet of claim 9 wherein the synthetic polymer is poly-ethylene terephthalate, nylon, polypropylene or blends thereof.

17. A spinneret plate for forming a solid core, fibrillation-resistant, synthetic polymeric filament having a longitudinal axis extending therethrough and a three-sided cross section in a plane perpendicular to the longitudinal axis,
the spinneret plate having a plurality of orifices formed therein, each orifice having a center and three sides, each side terminating in a first and a second end point, each side having a midpoint between the first and second end points,
the first end point of one side being connected to the second end point of an adjacent side by a circular end contour, the circular end contour having a radius equal to a dimension “C” measured from a center point lying on a radial line emanating from the center of the orifice, the center point of each end contour being disposed a predetermined distance “D” from the center of the orifice,
the first end point of each side being spaced from the second end point of an adjacent side along a chord defined between the end points of adjacent sides, and,
a point on each circular end contour lying on a circumscribed circle having a radius “(C+D)” centered on the center of the orifice, the midpoints of each side lying on a inscribed circle having a radius “H” centered on the center of the orifice, wherein
the distance “C” lies in the range 0.0015 inches (38 micrometers)<“C”<0.0040 inches (102 micrometers);
the distance “D” lies in the range from 0.0150 inches (381 micrometers)<“D”<0.0300 inches (762 micrometers).

18. The spinneret plate of claim 17 wherein
the distance “C” lies in the range 0.0020 inches (51 micrometers)<“C”<0.0035 inches (89 micrometers);
the distance “D” lies in the range from 0.0175 inches (445 micrometers)<“D”<0.0280 inches (711 micrometers).

19. The spinneret plate of claim 17 wherein each end point of each side is a point of tangency of a circular end contour.

20. The spinneret plate of claim 17 wherein
each side of each orifice is substantially concave with each side lying on a reference circle having a center located on a reference radius emanating from the center point of the orifice and passing through a midpoint of a side,
the center of the reference circle being disposed a predetermined distance “A” along the reference radius from the central axis of the orifice, the reference circle having a radius of dimension “B”,
the orifice has a modification ratio (“MR”) defined by the ratio of the radius (C+D) of the circumscribed circle to the radius “(A−B)” of the inscribed circle, thus,
“MR”=(C+D)/“H”, wherein
the distance “A” lies in the range 0.0300 inches (762 micrometers)<“A”<0.0900 inches (2286 micrometers);
the distance “B” lies in the range from 0.0200 inches (508 micrometers)<“B”<0.0700 inches (2032 micrometers);
the ratio (A/B) lies within the range from about 1.0<(A/B)< about 1.6; and
the modification ratio (“MR”) lies in the range from about 1.5<“MR”< about 4.5.

21. The spinneret plate of claim 20 wherein
the distance “A” lies in the range 0.0300 inches (762 micrometers)<“A”<0.0800 inches (2032 micrometers);
the distance “B” lies in the range from 0.0200 inches (508 micrometers)<“B”<0.0800 inches (1778 micrometers);
the ratio (A/B) lies within the range from about 1.1<(A/B)< about 1.5; and
the modification ratio (“MR”) lies in the range from about 1.8<“MR”< about 3.5.

22. The spinneret plate of claim 17 wherein each side of each orifice is substantially linear,
a point on each circular end contour lying on a circumscribed circle having a radius “(C+D)” centered on the center of the orifice,
the midpoints of each side lying on a inscribed circle having a radius “H” centered on the center of the orifice, wherein
the distance “H” lies in the range from 0.0090 inches (229 micrometers)<“H”<0.0190 inches (483 micrometers),
the orifice has a modification ratio (“MR”) defined by the ratio of the radius (C+D) of the circumscribed circle to the radius “H” of the inscribed circle, thus,
“MR”=(C+D)/“H”, wherein
the modification ratio (“MR”) lies in the range from about 1.6<“MR”< about 2.5.

23. The spinneret plate of claim 22 wherein
the distance “H” (i.e., the radius of the inscribed circle) lies in the range from 0.0108 inches (274 micrometers)<“H”<0.0175 inches (445 micrometers)
the modification ratio (“MR”) lies in the range from about 1.7<“MR”< about 2.3.

24. A spinneret plate for forming a solid core, fibrillation-resistant, synthetic polymeric filament having a longitudinal axis extending therethrough and a three-sided cross section in a plane perpendicular to the longitudinal axis,
the spinneret plate having a plurality of orifices formed therein, each orifice having a center and three sides, each side terminating in a first and a second end point, each side having a midpoint between the first and second end points,
the first end point of each side being spaced from the second end point of an adjacent side by a baseline defined between the end points of adjacent sides, the baseline intersecting with a reference radius emanating from the center point, the intersection point between the baseline and the reference radius lying a distance “G” along the reference radius from the center of the orifice, the baseline having a predetermined length “2F”,
the first end point of one side being connected to the second end point of an adjacent side by a end contour having at least two linear edges, the linear edges intersecting in an apex, the apex being spaced from the intersection of the baseline and the reference radius by a dimension “E”, wherein
the distance “E” lies in the range 0.0025 inches (64 micrometers)<“E”<0.0150 inches (381 micrometers);
the distance “F” lies in the range from 0.0015 inches (38 micrometers)<“F”<0.0040 inches (102 micrometers); and
the distance “G” lies in the range from 0.0150 inches (381 micrometers)<“G”<0.0300 inches (762 micrometers).

25. The spinneret plate of claim 24 wherein
the distance “E” lies in the range 0.0030 inches (76 micrometers)<“E”<0.0100 inches (254 micrometers);
the distance “F” lies in the range from 0.0020 inches (51 micrometers)<“F”<0.0035 inches (89 micrometers); and
the distance “G” lies in the range from 0.0175 inches (445 micrometers)<“G”<0.0280 inches (711 micrometers).

26. The spinneret plate of claim 24 wherein
each side of each orifice is substantially concave with each side lying on a reference circle having a center located on a reference radius emanating from the center point of the orifice and passing through a midpoint of a side,
the center of the reference circle being disposed a predetermined distance “A” along the reference radius from the central axis of the orifice, the reference circle having a radius of dimension “B”,
the orifice has a modification ratio (“MR”) defined by the ratio of the radius (E+G) of the circumscribed circle to the radius “(E+G)” of the inscribed circle, thus,
“MR”=(C+D)/“(A−B)”, wherein
the distance “A” lies in the range 0.0300 inches (762 micrometers)<“A”<0.0900 inches (2286 micrometers);
the distance “B” lies in the range from 0.0200 inches (508 micrometers)<“B”<0.0800 inches (2032 micrometers);
the ratio (A/B) lies within the range from about 1.0<(A/B)< about 1.6; and
the modification ratio (“MR”) lies in the range from about 1.5<“MR”< about 4.5.

27. The spinneret plate of claim 26 wherein
the distance “A” lies in the range 0.0300 inches (762 micrometers)<“A”<0.0800 inches (2032 micrometers);
the distance “B” lies in the range from 0.0200 inches (508 micrometers)<“B”<0.0800 inches (1778 micrometers);
the ratio (A/B) lies within the range from about 1.1<(A/B)< about 1.5; and
the modification ratio (“MR”) lies in the range from about 1.8<“MR”< about 3.5.

28. The spinneret plate of claim 24 wherein each side of each orifice is substantially linear,
the apex on each circular end contour lying on a circumscribed circle having a radius “(G+E)” centered on the center of the orifice,
the midpoints of each side lying on a inscribed circle having a radius “H” centered on the center of the orifice, wherein
the midpoints of each side lying on a inscribed circle having a radius “H” centered on the center of the orifice, wherein
the distance “H” lies in the range from 0.0088 inches (224 micrometers)<“H”<0.0185 inches (470 micrometers),
the orifice has a modification ratio (“MR”) defined by the ratio of the radius (G+E) of the circumscribed circle to the radius “H” of the inscribed circle, thus,
“MR”=(G+E)/“H”, wherein
the modification ratio (“MR”) lies in the range from about 1.6<“MR”< about 2.5.

29. The spinneret plate of claim 28 wherein
the distance “H” (i.e., the radius of the inscribed circle) lies in the range from 0.0105 inches (267 micrometers)<“H”<0.0170 inches (432 micrometers)
the modification ratio (“MR”) lies in the range from about 1.7<“MR”< about 2.3.

30. A process for making a solid core, fibrillation-resistant, synthetic polymeric filament having a longitudinal axis extending therethrough and a three-sided cross section in a plane perpendicular to the longitudinal axis,
the sides being substantially equal in length and convex in form, each side having a midpoint therealong, each midpoint lying on an inscribed circle centered on the central axis of the filament, the inscribed circle having a radius substantially equal to a length “c”,
each side meeting an adjacent side through a substantially rounded tip centered on a respective circle of curvature, each circle of curvature having a radius substantially equal to a length “b”, each circle of curvature being spaced from the axis of the filament by a distance “a”, each tip of the filament lying on a circumscribed circle having a radius substantially equal to a length (a+b),
the filament having a modification ratio (MR) defined by the ratio of the radius (a+b) of the circumscribed circle to the radius (c) of the inscribed circle, wherein
the filament has a denier-per-filament (“dpf”) in the range 10<“dpf”<35;
the distance “a” lies in the range 0.00025 inches (6 micrometers)<“a”<0.004 inches (102 micrometers);
the distance “b” lies in the range from 0.00008 inches (2 micrometers)<“b”<0.0010 inches (24 micrometers);
the distance “c” lies in the range from 0.0003 inches (8 micrometers)<“c”<0.0025 inches (64 micrometers); and
the modification ratio (“MR”) lies in the range from about 1.1<“MR”< about 2.0.
the process comprising the steps of:
a) pumping molten synthetic polymer through a spinneret plate having a plurality of orifices to form filaments;
b) cooling the filaments;
c) applying a finish to the filaments;
d) drawing and annealing the filaments; and
e) bulking the filaments to impart a random, three-dimensional curvilinear crimp to the filaments

31. The process of claim 30 wherein
each orifice of the spinneret plate has a center and three sides, each side terminating in a first and a second end point, each side having a midpoint between the first and second end points,
the first end point of one side being connected to the second end point of an adjacent side by a circular end contour, the circular end contour having a radius equal to a dimension “C” measured from a center point lying on a radial line emanating from the center of the orifice, the center point of each end contour being disposed a predetermined distance “D” from the center of the orifice,
the first end point of each side being spaced from the second end point of an adjacent side along a chord defined between the end points of adjacent sides, and,
a point on each circular end contour lying on a circumscribed circle having a radius “(C+D)” centered on the center of the orifice, the midpoints of each side lying on a inscribed circle having a radius “H” centered on the center of the orifice, wherein
the distance “C” lies in the range 0.0015 inches (38 micrometers)<“C”<0.0040 inches (102 micrometers);
the distance “D” lies in the range from 0.0150 inches (381 micrometers)<“D”<0.0300 inches 762 micrometers).

32. The process of claim 30 wherein
each orifice of the spinneret plate has a center and three sides, each side terminating in a first and a second end point, each side having a midpoint between the first and second end points,
the first end point of each side being spaced from the second end point of an adjacent side by a baseline defined between the end points of adjacent sides, the baseline intersecting with a reference radius emanating from the center point, the intersection point between the baseline and the reference radius lying a distance “G” along the reference radius from the center of the orifice, the baseline having a predetermined length “2F”,
the first end point of one side being connected to the second end point of an adjacent side by a end contour having at least two linear edges, the linear edges intersecting in an apex, the apex being spaced from the intersection of the baseline and the reference radius by a dimension “E”, wherein
the distance “E” lies in the range 0.0025 inches (64 micrometers)<“E”<0.0150 inches (381 micrometers);
the distance “F” lies in the range from 0.0015 inches (38 micrometers)<“F”<0.0040 inches (102 micrometers); and
the distance “G” lies in the range from 0.0150 inches (381 micrometers)<“G”<0.0300 inches (762 micrometers).

33. The process of claim 30 wherein the synthetic polymer is poly-trimethylene terephthalate.

34. The process of claim 30 wherein the poly-trimethylene terephthalate has a 1,3propane diol that is biologically produced.
